(19) United States
(12) Patent Application Publication
(10) Pub. No.: US 2024/0399775 A1
(43) Pub. Date: Dec. 5, 2024

(54) DEVICE FOR MARKING CONTAINERS AND ASSOCIATED OPERATING METHOD

(71) Applicant: KRONES AG, Neutraubling (DE)

(72) Inventors: Florian LAUTERBACH, Illkofen (DE); Helmut SCHNEIDER, Regensburg (DE); Juergen FRANKERL, Nittenau (DE); Peter LINDNER, Langquaid (DE); Andreas KRAUS, Lappersdorf (DE); Soeren MEISSNER, Regensburg (DE); Bernd BRAATZ, Alteglofsheim (DE); Josef MAYER, Regensburg (DE)

(21) Appl. No.: 18/734,435

(22) Filed: Jun. 5, 2024

(30) Foreign Application Priority Data
Jun. 5, 2023 (DE) 10 2023 114 693.9

(51) Int. Cl. B41M 5/00; B41J 2/455; B41J 3/407; B41J 29/13; B41J 29/17; B41J 29/377; B41M 5/26; B65C 9/04; B65C 9/26; B65C 9/40

(52) U.S. Cl. CPC B41M 5/0082; B41J 2/455; B41J 3/40731; B41J 3/40733; B41J 29/13; B41J 29/17; B41J 29/377; B41M 5/26; B65C 9/04; B65C 9/26; B65C 9/40

(57) ABSTRACT

The invention relates, inter alia, to a device for marking containers for a container treatment system. The device has a container conveyor for transporting the containers. The device has a coupling unit, a labeling module, and a laser-marking module. The labeling module and the laser-marking module can be interchangeably coupled to the coupling unit. Advantageously, the device can be used particularly flexibly, because the labeling module and the laser-marking module can be coupled to the same coupling unit, so that the device can be used flexibly and as required for labeling with the labeling module or for laser-marking with the laser-marking module.

### CROSS REFERENCE TO RELATED APPLICATIONS

This application claims the benefit under 35 U.S.C. § 119 (a) of German Patent Application No. DE 10 2023 114 693.9, filed Jun. 5, 2023 entitled DEVICE FOR MARKING CONTAINERS AND ASSOCIATED OPERATING METHOD, and whose entire disclosure is incorporated by reference herein.

### TECHNICAL FIELD

The invention relates to a device for marking containers. The invention also relates to a method for operating a device for marking containers.

### TECHNICAL BACKGROUND

Standardly, the majority of containers are fitted with labels. Typical variants are paper or plastic labels, which are processed with hot or cold glue or are self-adhesive and applied to the containers. Labels can be problematic in the recycling process, e.g., due to the printing ink used, waterproof papers, glue, etc.

In principle, it is therefore desirable to dispense with labels completely. Required information could, for example, be marked or written directly on the containers using a laser-marking system. This technology is already used, for example, to laser mark a production number or a “best used before” date. During laser-marking, the laser beam and the heat it generates on the surface of the container can cause a physical change to the surface of the container (e.g., whitening of PET containers) so that the desired marks can be laser-marked on the surface.

The invention is based upon the object of creating a more flexible technique for marking containers for a container treatment system.

### SUMMARY OF THE INVENTION

The object is achieved by the features of the independent claims. Advantageous developments are specified in the dependent claims and the description.

One aspect of the present disclosure relates to a device, preferably a rotary device, for marking containers for a container treatment system. The device has a container conveyor, preferably a rotary container conveyor, for transporting the containers. The device also has a coupling unit and a labeling module that can be coupled to the coupling unit for applying labels to the containers transported by the container conveyor. The device also has a laser-marking module that can be coupled to the coupling unit for laser-marking the containers transported by the container conveyor. The labeling module and the laser-marking module can be interchangeably coupled to the coupling unit.

Advantageously, the device can be used particularly flexibly, because the labeling module and the laser-marking module can be coupled to the same coupling unit, so that the device can be used flexibly and as required for labeling with the labeling module or for laser-marking with the laser-marking module. Changing between the labeling module and laser-marking module is comparatively quick and easy thanks to the modular design and the coupling unit. Advantageously, for example, a first product can be provided with labels by the labeling module, and, after changing the modules, a second product can easily be marked with a laser-marking by the laser-marking module. Advantageously, this technology also allows devices already in operation to be easily retrofitted with coupling unit(s) and labeling module(s) for laser-marking, because the laser-marking module fits onto the existing coupling unit(s). This also makes it possible to achieve a comparatively low-cost transition to completely label-free containers.

Preferably, a laser marking applied by the laser-marking module can comprise a decoration, a decorative surface, at least one character, and/or a single-line or multi-line character sequence.

In one exemplary embodiment, the device also has (at least) one further coupling unit, which is arranged upstream or downstream of the coupling unit with respect to a container transport direction of the container conveyor. The device also has (at least) one further laser-marking module, which can be coupled to the (at least one) further coupling unit for laser-marking the containers transported by the container conveyor. Optionally, the coupling unit and the (at least one) further coupling unit can be of identical construction. Optionally, the laser-marking module and the (at least one) further laser-marking module can be of identical construction. By attaching additional laser-marking modules, the output (=laser-marked containers per hour) of the device can be flexibly increased, and, ultimately, the production of completely label-free and only laser-marked containers with high output is also possible.

Preferably, at least one marking head of the laser-marking module can have a relative position to the container conveyor when the laser-marking module is coupled to the coupling unit which differs from a relative position between at least one further marking head of the further laser-marking module and the container conveyor when the further laser-marking module is coupled to the further coupling unit. The laser-marking modules can therefore advantageously laser-mark different regions of the containers one after the other—for example, in order to process large-format laser markings and/or laser markings having many characters with a high output (=laser-marked containers per hour).

Preferably, the device can have (at least) one further labeling module, which can be coupled to the (at least one) further coupling unit for applying labels to the containers transported by the container conveyor. The (at least one) further labeling module and the (at least one) further laser-marking module can be coupled to the (at least one) further coupling unit so as to be interchangeable with one another.

It is also possible, for example, for a labeling module and a laser-marking module to be coupled to a coupling unit on the device. Advantageously, the combination of labeling and laser-marking modules in one device can enable combined decorations.

In a further exemplary embodiment, the labeling module and/or the laser-marking module have rollers for moving over a surface. Advantageously, each module can thus be easily moved towards and away from the coupling unit.

In one embodiment, the coupling unit is configured so that the labeling module is lifted when it is coupled to the coupling unit and/or that the laser-marking module is lifted when it is coupled to the coupling unit. The advantage of this is that a very precise positioning of the module can be achieved, and the influence of uneven floors, etc., on the positioning accuracy can be eliminated.

In a further embodiment, the laser-marking module has a movable module carriage and a laser-marking system for laser-marking, which is preferably arranged as an exchangeable submodule on the module carriage (and secured, for example, preferably with a quick-release fastener or a tool-free quick-change system). This has the advantage of further increasing flexibility, because, for example, different laser-marking systems can be quickly and easily arranged and secured on the module carriage as a submodule for different laser-marking tasks.

Preferably, the labeling module can have a movable module carriage that is identical in construction to the module carriage of the laser-marking module. This has the advantage of further increasing the flexibility of the module design.

In a further embodiment, the laser-marking module has at least one marking head for laser-marking the containers, wherein a position of the at least one marking head is adjustable (e.g., manually or by motor)—preferably adjustable in height-transversely to a transport direction of the container conveyor and/or longitudinally to a transport direction of the container conveyor and/or radially to the container conveyor. Advantageously, the laser-marking module can thus be adaptable, e.g., in order to be able to set a desired distance to the container to be laser-marked, to be able to laser-mark different areas of containers, or to be able to adapt the laser-marking module to different container formats.

In a further embodiment, the laser-marking module has a plurality of marking heads for laser-marking different areas of the containers. Optionally, the multiple marking heads can be arranged one above the other or laterally next to each other. Alternatively or additionally, the plurality of marking heads can share a laser source and/or other peripheral equipment, such as a cooling system (e.g., the cooling device disclosed herein). In this way, very large-format and/or distributed laser markings can be applied to the containers with high output (=laser-marked containers per hour).

In one embodiment, the laser-marking module has a suction device for suctioning off vapors generated during laser-marking. Advantageously, a further functionality can in this way be integrated into the laser-marking module, wherein the integrated suction device can prevent contamination of the device and the containers by the vapors.

In one embodiment, the laser-marking module has a cooling device (e.g., air cooling device, liquid cooling device, or electric cooling device) which is connected to the (at least one) laser source of the laser-marking module in a heat-transferring manner for cooling (at least) one laser source, preferably for cooling the laser source with cooling water. Advantageously, a further functionality can in this way be integrated into the laser-marking module, wherein the integrated cooling device also enables comparatively powerful laser sources to be used and/or the service life of the laser source to be extended.

In a further exemplary embodiment, the laser-marking module has a cleaning device for automatically cleaning a focusing device of the laser-marking module. Advantageously, a further functionality can in this way be integrated into the laser-marking module, wherein the integrated cleaning device can support a consistent quality of the laser markings on the containers.

In a further embodiment, the laser-marking module has a—preferably camera-supported-detection device for detecting a position and/or orientation of a marking area of the containers individually for each container in order to adapt the laser-marking to the detected position and/or orientation. Advantageously, a further functionality can in this way be integrated into the laser-marking module, wherein the integrated detection device can improve the positioning accuracy of the laser-marking in the marking area of each of the containers.

In a variant embodiment, the laser-marking module has a laser-protection housing for shielding the laser-marking of the containers. Advantageously, a further functionality can in this way be integrated into the laser-marking module, wherein the integrated laser-protection housing can prevent injury to operators from the laser beam in the event of improper use.

In a further embodiment, the laser-protection housing or at least a part thereof (e.g., a flap, a door, or a window) is movable, preferably guided, (e.g., manually or automatically), and preferably capable of being raised and lowered, between an operating position and a maintenance position. This can substantially improve the ergonomics.

In one embodiment, the laser-marking module has a locking device, preferably mechanical and/or electronic, for locking the laser-protection housing or at least a part thereof in the operating position. Optionally, the locking device can be configured to lock the laser-protection housing or at least part of it in the operating position when the laser-marking module is coupled to the coupling unit. Alternatively or additionally, the locking device can be configured to release the laser-protection housing or at least part of it for movement into the maintenance position when the laser-marking module is uncoupled from the coupling unit. The advantage of this is that a particularly high level of safety can be achieved.

Preferably, the suction device, the cooling device, the cleaning device, the detection device, the laser-protection housing, and/or the locking device can (in each case) be arranged as an exchangeable submodule on the module carriage (and, for example, secured, preferably with a quick-release fastener or a tool-free quick-change system). This has the advantage of further increasing flexibility, since different submodules can be quickly and easily arranged and secured on the module carriage for different tasks, for example.

In a further exemplary embodiment, the device has a control device that is configured:
to operate the device in a first operating mode with at least one first operating parameter, preferably comprising a first conveying speed, when the labeling module is coupled to the coupling unit, and
to operate the device in a second operating mode with at least one second operating parameter, preferably comprising a second conveying speed, which is different from the at least one first operating parameter, when the laser-marking module is coupled to the coupling unit.

The advantage of this is that not only can the structure of the device be changed quickly thanks to the modular approach, but the control configuration can also be changed quickly and automatically to suit the particular structure with adapted, optimum operating parameters in each case.

Preferably, the term “control device” can refer to an electronic system (e.g., embodied as a driver circuit or with microprocessor(s) and data memory) and/or a mechanical, pneumatic, and/or hydraulic controller which can take over control tasks and/or regulation tasks and/or processing tasks, depending on the configuration. Although the term “control” is used herein, this can also comprise or be understood as “regulate” or “feedback-control” and/or “process.”

For example, the control device can be a central control device of the device. Alternatively, the control device can be distributed decentrally, e.g., partially on the laser-marking module and/or the labeling module.

In one embodiment, the container conveyor is configured to rotate the containers about a vertical axis of each container (e.g., by means of rotatable container holders of the container conveyor). Preferably, the at least one first operating parameter may comprise a first container rotation speed and/or a first container rotation profile for rotating the containers about the vertical axis of the respective container, and the at least one second operating parameter may comprise a second container rotation speed, which is different from the first container rotation speed, and/or a second container rotation profile, which is different from the first container rotation profile, for rotating the containers about the vertical axis of each container. This advantageously makes it possible to automatically coordinate a rotation of the containers and the type of marking (labeling and/or laser-marking) with one another.

In a further embodiment, the device also has an inspection device which is configured to detect the laser markings applied to the containers by the laser-marking module and to adapt operation of the device (e.g., the control device), depending upon the detected laser markings. Advantageously, in this way the applied laser markings can be monitored. It is also possible to adjust (e.g., regulate or control) certain operating parameters of the device—for example, of the container conveyor or the laser-marking module.

It is possible for the suction device, the cooling device, the detection device, the cleaning device, the laser-protection housing, the locking device, the control device, and/or the inspection device to be a part of the laser-marking module or to be included separately from the laser-marking module as a part of the device.

Another aspect of the present disclosure relates to a container handling system for manufacturing, cleaning, coating, testing, filling, sealing, marking, and/or packaging containers for liquid media, preferably beverages or liquid foodstuffs, with a device for marking as disclosed herein or with a laser-marking module as disclosed herein.

For example, the containers can be configured as bottles, cans, canisters, cartons, vials, etc.

A further aspect of the present disclosure relates to a laser-marking module as disclosed herein.

A further aspect of the present disclosure relates to a device for marking containers as disclosed herein, without a labeling module.

A further aspect relates to a method of operating a device for marking containers as disclosed herein. The method comprises operating the device in a first operating mode, in which the labeling module is coupled to the coupling unit, with at least one first operating parameter, preferably comprising a first conveying speed, a first container rotation speed, and/or a first container rotation profile. The method comprises operating the device in a second operating mode, in which the laser-marking module is coupled to the coupling unit, with at least one second operating parameter, preferably comprising a second conveying speed, a second container rotation speed, and/or a second container rotation profile, which differs from the at least one first operating parameter. Advantageously, the method can achieve the same advantages as already described with reference to the apparatus.

Preferably, in the second operating mode, no labels can be applied to the containers by the device.

Preferably, in the second operating mode, the containers can be marked in completely label-free fashion by the device, i.e., they can be laser-marked only, using the laser-marking module.

For example, in the second operating mode, no labeling module can be coupled to the device.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a schematic representation of an exemplary laser-marking system; and

FIG. 2 shows a schematic representation of an exemplary device for marking containers.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

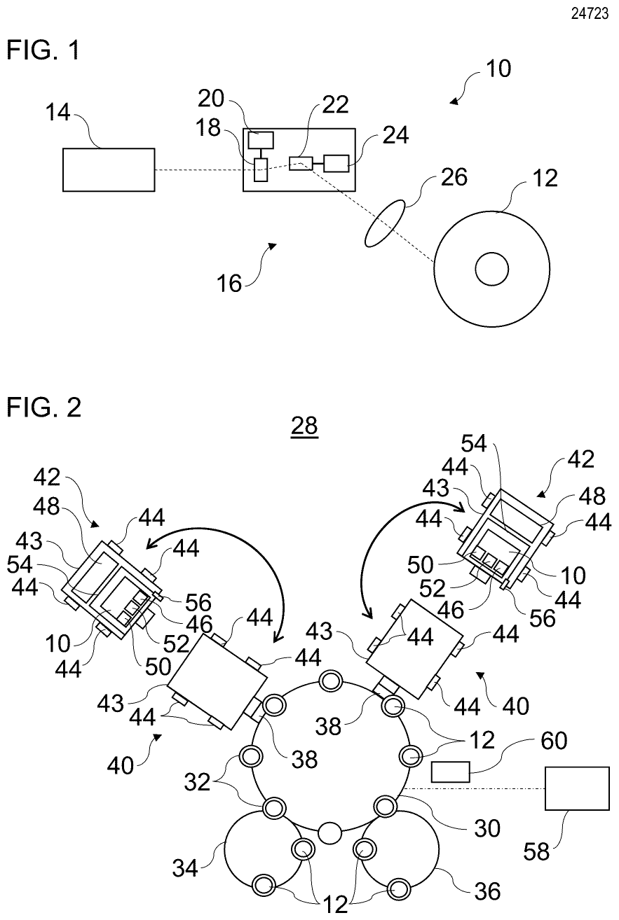

FIG. 1 shows a laser-marking system 10 for laser-marking containers 12. The laser-marking system 10 can also be referred to as a laser identification system, laser-coding system or laser-inscription system. Preferably, the laser-marking system 10 can be a CO2 laser-marking system, a fiber laser-marking system or a UV laser-marking system.

Preferably, the laser-marking system 10 can have a laser source 14 and a marking head 16.

The laser source 14 can be configured as a laser tube, for example. The laser tube may be sealed. The laser tube can be filled with a gas, e.g., containing CO₂, or a gas mixture, e.g., a CO₂—N₂—He gas mixture. Electrodes can also be arranged in the laser tube. A supply unit can be connected to the electrodes (not shown in FIG. 1). The supply unit can supply the laser source 14 with electrical energy. By means of a, for example, high-frequency voltage, molecules, e.g., CO₂ molecules, can be excited to oscillate in the laser tube and thus to emit a laser beam. The laser source 14 can also be referred to as an oscillator.

The laser beam generated by the laser source 14 can be guided or directed to the marking head 16 directly or via mirrors. It is possible for a so-called telescope for expanding the laser beam to be arranged between the laser source 14 and the marking head 16, for example.

The marking head 16 can preferably have two movable mirrors 18 and 22 and two drives 20 and 24. The marking head 16 can also have a focusing device 26. The marking head 16 can also be referred to as a coding head or writing head.

The first drive 20 can rotate the first mirror 18 about a first axis (e.g., x-axis). The first mirror 18 can, for example, also be referred to as a movable scanner mirror, e.g., an X-scanner mirror. The second drive 24 can rotate the second mirror 22 about a second axis (e.g., y-axis). The second mirror 22 can, for example, also be referred to as a movable scanner mirror, e.g., a Y-scanner mirror. The first axis and the second axis can preferably run perpendicular to each other.

The mirrors 18, 22 moved by the drives 20, 24 can direct the laser beam according to the desired laser-marking. This allows the laser beam to move across the surface of the container 12 while writing, for example. Preferably, the laser beam can move across the surface of the container 12 within a marking field that is assigned to the respective marking head 16.

Before the laser beam impinges on the surface of the container 12, it can be focused by means of a focusing device 26. The focusing device 26 can, for example, have a focusing lens for this purpose. The focusing lens can also be referred to as a condenser lens. The focusing lens can be an F-theta lens, for example. Depending upon the configuration, the focusing lens can be arranged inside or outside the marking head 16. The focusing device 26 can also have a protective disk to protect the focusing lens, for example.

It is possible for the laser-marking system 10 to have a plurality of marking heads 16. The multiple marking heads 16 can, for example, be arranged laterally side-by-side and/or one above the other. For example, two, three, or more marking heads 16 can be included.

Each marking head 16 can be connected to its own laser source 14, which can emit a laser beam to the respective marking head 16. Accordingly, the laser-marking system 10 can have a plurality of laser sources 14.

It is also possible for a plurality of marking heads 16 to each receive their laser beams from the same laser source 14. For example, a beam splitter can be arranged between the laser source 14 and a plurality of marking heads 16. The beam splitter can, for example, split a laser beam received from the laser source 14 into a plurality of laser beams and guide these to the plurality of marking heads 16.

If a plurality of laser sources 14 are included, these can, for example, be of identical design. However, it is also possible for the laser sources 14 to be at least partially designed differently in order to be able to produce different effects (e.g., color effects, haptic effects, surface structures) when laser-marking the containers 12.

FIG. 2 shows, purely schematically and as an example, a device 28 for marking containers 12.

The device 28 has a container conveyor 30, at least one coupling unit 38, at least one labeling module 40, and at least one laser-marking module 42. The container processing system 28 can also have a control device 58.

The container conveyor 30 is configured for transporting containers 12. The container conveyor 30 can transport the containers 12 in a transport direction.

Preferably, the container conveyor 30 can be a rotary container conveyor (container conveyor carousel). Alternatively, the container conveyor 30 can, for example, be a linear container conveyor (not shown in FIG. 2).

The container conveyor 30 can support the containers 12 during transport, preferably on their base side, circumferential side, and/or mouth side. The container conveyor 30 can have container holders 32 for supporting the containers 12. The container holders 32 can preferably hold the containers 12 in base handling or neck handling.

It is possible that the container conveyor 30 has no separate container holders 32, and, for example, the containers 12 are simply supported on a, preferably circulating, conveying element (e.g., band, strap, belt, chains, or plates) of the container conveyor 30 (not shown in FIG. 2).

For example, the container holders 32 can each support a container 12. The container holders 32 can, for example, each have a container plate (e.g., container turntable), a centering bell, a container clamp, and/or an inflation device. For example, one container 12 can be fixed between a container plate and a centering bell in each case. An optional, additional inflation device can provide additional stability, e.g., if the containers 12 are marked before filling.

Preferably, the container conveyor 30 can be configured to rotate each of the transported containers 12 about its own vertical axis. Preferably, the container holders 32 can be rotatable for rotating the containers 12 about their respective vertical axis.

An infeed conveyor 34 can feed the containers 12 to the container conveyor 30. The infeed conveyor 34 can be configured as a transfer star, for example. It is possible that the infeed conveyor 34 is configured for a division delay or for modifying a division delay.

An outfeed conveyor 36 can transport the containers 12 away from the container conveyor 30 after the marking. The outfeed conveyor 36 can be configured as a transfer star, for example.

The at least one coupling unit 38 is configured for coupling to the modules 40, 42, which in turn are configured for coupling to the at least one coupling unit 38.

A particular feature of the present disclosure can be that the labeling module(s) 40 and the laser-marking module(s) 42 are couplable to the same coupling unit(s) 38. The labeling module(s) 40 and the laser-marking module(s) 42 can thus be interchangeably coupled to the coupling unit(s) 38.

Preferably, the device 28 has a plurality of coupling units 38, e.g., between two and six coupling units 38. To improve readability, reference is made below primarily to the plural form with regard to the coupling units 38. It will be understood that the explanations can equally apply to embodiments comprising only one coupling unit 38.

The coupling units 38 are preferably of identical construction. However, it is also possible for the coupling units 38 to be at least partially designed differently.

The coupling units 38 can be arranged one after the other and at a distance from one another with respect to a transport direction of the container conveyor 30. The coupling units 38 can be arranged on an outer side, e.g., outer circumferential side, of the container conveyor 30.

The coupling units 38 can be configured so that the relevant coupling module 40, 42 is lifted when coupling to the relevant coupling unit 38. For example, the coupling units 38 can each have a lifting device. The lifting devices can have a motorized drive, for example. The coupling module 40, 42 can be lifted by means of a lifting device. For example, when coupling, the lifting device can lift the module 40, 42 into an operating position in which the module 40, 42 preferably no longer has direct contact with the ground. On the other hand, during uncoupling, the lifting device can lower the module 40, 42 into an initial position in which the module 40, 42 is preferably in direct contact with the ground and can be moved away.

Preferably, the coupling units 38 can be configured for the mechanical coupling and uncoupling of a module 40, 42. For example, the coupling units 38 can each have a centering cone that mates with a centering cone of the corresponding module 40, 42 for positioning the module 40, 42.

When uncoupled, the modules 40, 42 can be moved, preferably driven, over a surface.

For example, the modules 40, 42 can each have a movable module carriage 43 for moving over the surface. The module carriages 43 can preferably be configured as mobile underframes. The module carriages 43 of the modules 40, 42 can preferably be identical in construction. The module carriage 43 of the labeling module 40 can carry an exchangeable labeling unit for labeling the containers 12. The module carriage 43 of the laser-marking module 42 can carry the exchangeable laser-marking system 10.

Preferably, the modules 40, 42 or the module carriages 43 can each have a plurality of rollers 44 for moving over the surface. Preferably, the rollers 44 are not in contact with the ground in the operating position of the relevant module 40, 42.

Preferably, the device 28 has a plurality of labeling modules 40. To improve readability, reference is made below primarily to the plural form with regard to the labeling modules 40. It will be understood that the explanations can equally apply to embodiments comprising only one labeling module 40.

The labeling modules 40 are configured to apply labels to the containers 12. Specifically, the labeling modules 40 can apply labels to the containers 12 when they are coupled to the coupling units 38.

The labeling modules 40 can, for example, apply paper or plastic labels to the containers 12. The labels can be applied to the containers 12 using hot glue, cold glue, or in self-adhesive fashion, for example.

Preferably, the device 28 has a plurality of laser-marking modules 42. To improve readability, reference is made below primarily to the plural form with regard to the laser-marking modules 42. It will be understood that the explanations can equally apply to embodiments comprising only one laser-marking module 42.

The laser-marking modules 42 are configured for laser-marking the containers 12. Specifically, the laser-marking modules 42 can apply laser markings to the containers 12 when they are coupled to the coupling units 38.

The laser-marking modules 42 each have a laser-marking system 10 each having one or more marking heads 16 (see FIG. 1). Preferably, a position of at least one marking head 16 of the laser-marking system 10 can be adjustable. The adjustment device for adjusting the position of the at least one marking head 16 can, for example, be manually operated or motor-driven. The adjustment device preferably has a guide with which the at least one marking head 16 can be guided during adjustment. For example, the at least one marking head 16 can be height-adjustable. Alternatively or additionally, the at least one marking head 16 can, for example, be adjustable transversely to a transport direction of the container conveyor 30 and/or longitudinally to a transport direction of the container conveyor 30.

Preferably, the laser-marking modules 42 are identical in construction. Preferably, the laser-marking modules 42 are set so that they can mark different sections of the containers 12, e.g., a plurality of sections arranged one above the other. For example, a marking head 16 (see FIG. 1) of a laser-marking module 42 can be positioned in a higher position than a marking head 16 (see FIG. 1) of another laser-marking module 42. For example, the aforementioned adjustability or adjustment device can be used for the adjustment.

The laser-marking modules 42 can particularly preferably have further devices, with which an operation of the respective laser-marking module 42 can be improved. For example, the laser-marking modules 42 can each have a suction device 46, a cooling device 48, a detection device 50, a cleaning device 52, a laser-protection housing 54, and/or a locking device 56.

Particularly preferably, the laser-marking system 10, the suction device 46, the cooling device 48, the detection device 50, the cleaning device 52, the laser-protection housing 54, and/or the locking device 56 can each be configured as an exchangeable submodule for arrangement on the module carriage 43 as required, e.g., by means of a quick-change system, preferably one without tools. The module carriage 43 can have at least one submodule receptacle for holding at least one submodule.

The suction device 46 can be configured to suction vapors generated during the laser-marking.

For example, the suction device 46 can be directed towards a marking field of the laser-marking system 10 when the respective laser-marking module 42 is coupled to the coupling unit 38. Preferably, the suction device 46 is arranged above the at least one marking head 16 (see FIG. 1) and/or the container conveyor 30 when the relevant laser-marking module 42 is coupled to the coupling unit 38.

The suction device 46 can preferably be arranged inside the laser-protection housing 54. The suction device 46 can be accessible in a maintenance position of the laser-protection housing 54.

The test device 46 can have, for example, a fan and a pipe system. The fan can convey vapors suctioned off from the laser-marking through the pipe system. The pipe system can include a filter, for example. The pipe system can discharge into the environment or a reservoir, e.g., a tank.

The cooling device 48 can be connected to the laser source 14 of the laser-marking system 10 in a heat-transferring manner in order to cool the laser source 14. The cooling device 48 can, for example, be an air cooling device, a liquid cooling device, or an electric cooling device. Preferably, the cooling device 48 can carry a cooling liquid, e.g., cooling water, in a cooling circuit. A first heat exchanger can connect the laser source 14 to the cooling circuit for cooling the laser source 14 in a heat-transferring manner. A second heat exchanger can connect the cooling circuit to a surrounding environment in a heat-transferring manner. The second heat exchanger can preferably be supplied with ambient air by a fan.

Preferably, the cooling device 48 can be arranged at least partially outside the laser-protection housing 54, e.g., in order to facilitate maintenance. For example, the second heat exchanger and optionally also the first heat exchanger can be arranged outside the laser-protection housing 54.

The detection device 50 can be configured for container-individual detection of a position and/or orientation of a marking area of each of the containers 12. The detection device 50 can, for example, have at least one camera. The detection device 50 can be directed towards the container conveyor when the laser-marking module 42 is coupled to the coupling unit 38.

Using the detected position and/or orientation of the marking area, a control device 58 can adapt the operation of the laser-marking system 10, preferably to the individual container.

Preferably, the detection device 50 can be arranged outside the laser-protection housing 54.

The cleaning device 52 can be configured to automatically clean the focusing device 26 of the laser-marking system 10. Specifically, the cleaning device 52 can, for example, automatically clean a focusing lens and/or a protective screen of the focusing device 26.

For example, the cleaning device 52 can clean the focusing device 26 at regular intervals and/or after triggering by a user input device.

The cleaning device 52 can spray the focusing device 26 with a cleaning fluid, e.g., air or cleaning fluid—for example, by means of a nozzle. For example, the nozzle can be connected to the environment via a compressor or to a cleaning fluid tank via a pump. Alternatively or additionally, the cleaning device 52 can clean, e.g., wipe, the focusing device 26, for example, with a fabric or a (e.g., windshield) wiper.

Preferably, the cleaning device 52 can be arranged inside the laser-protection housing 54. The cleaning device 52 can be accessible in a maintenance position of the laser-protection housing 54.

The laser-protection housing 54 can be configured to shield the laser-marking of the containers 12. For example, the laser-protection housing 54 can have housing walls and/or tinted panes for shielding the laser-marking.

The laser-protection housing 54 is preferably movable between an operating position and a maintenance position. The movement can be effected manually or automatically. The movement of the laser-protection housing 54 can be guided by a (e.g., vertical) guide. Preferably, the laser-protection housing 54 can be raised from the operating position to the maintenance position and lowered from the maintenance position to the operating position.

Preferably, the laser source 14, the marking head 16, and/or the focusing device 26 can be arranged so as to be protected in the laser-protection housing 54 in the operating position. In the maintenance position, the laser source 14, the marking head 16, and/or the focusing device 26 can be accessible.

The optional locking device 56 can be configured to lock the laser-protection housing 54 in the operating position. The locking device 56 can, for example, be a mechanical and/or electronic locking device.

For example, the locking device 56 can electronically monitor, using an appropriate sensor system or the like, whether or not the laser-marking module 42 is coupled to the coupling unit 38. It is also possible for the locking device 56 to have, for example, a mechanical switch that is actuated when coupling to the coupling unit 38 or when uncoupling from the coupling unit 38.

Preferably, the locking device 56 can lock the laser-protection housing 54 in the operating position when the laser-marking module 42 is coupled to the coupling unit 38 and/or release the laser-protection housing 54 for movement into the maintenance position when the laser-marking module 42 is uncoupled from the coupling unit 38.

The locking of the laser-protection housing 54 in the operating position by means of the locking device 56 can, for example, be carried out electronically and/or mechanically. For example, the locking device 56 can interrupt an electrical supply line to a drive for moving the laser-protection housing 54. It is also possible for a movable latch or the like of the locking device 56 to block the laser-protection housing 54 in the operating position.

Alternatively or in addition to the laser-protection housing 54 of the laser-marking module 42, it is also possible for the container conveyor 30 and/or a machine frame of the device 28 to be equipped with a protective device for shielding the laser-marking—for example, in at least one intermediate space between adjacent coupling units 38.

The control device 58 can be configured to operate the device 28 in a first mode of operation when at least one labeling module 40 is coupled to the one or more coupling units 38, and to operate the device 28 in a second mode of operation when at least one laser-marking module 42 is coupled to the one or more coupling units 38.

In the first operating mode, the device 28 can be operated with different operating parameters than in the second operating mode. For example, in the first operating mode, a container conveying speed, a container rotational speed (with respect to rotation about a vertical axis of the container 12), and/or a container rotation profile may have a different value in each case than in the second operating mode. For example, the container rotation profile can indicate whether the containers 12 are rotated about their own vertical axis at all, when the containers 12 are rotated about their own vertical axis, for how long the containers 12 are rotated about their own vertical axis, at what speed the containers 12 are rotated about their own vertical axis, and/or by what angle of rotation the containers 12 are rotated about their own vertical axis—for example, by the container holders 32.

Optionally, the device 28 can have a—preferably camera-supported-inspection device 60. The inspection device 60 can detect the laser markings applied to the containers 12 by the laser-marking module 42 and check or evaluate them—for example, with regard to quality, etc. Depending upon the evaluation, the operation of the device 28 can be adapted (e.g., via the control device 58). For example, a container transport speed of the container conveyor 30 or a container rotational speed of the container conveyor 30 can be reduced if it is detected that the applied laser markings are incomplete, or a warning can be issued to a user via an output device.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the container conveyor, the coupling unit, the labeling module, and/or the laser-marking module of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 laser-marking system
12 container
14 laser source
16 marking head
18 first mirror
20 first drive
22 second mirror
24 second drive
26 focusing device
28 device for marking containers
30 container conveyor
32 container holder
34 infeed conveyor
36 outfeed conveyor
38 clutch unit
40 labeling module
42 laser-marking module
43 module carriage
44 roller
46 suction device
48 cooling device
50 detection device
52 cleaning device
54 laser-protection housing
56 locking device
58 control device
60 inspection device

What is claimed is:

1. A device for marking containers for a container treatment system, the device having:
a container conveyor for transporting the containers;
a coupling unit;
a labeling module which is couplable to the coupling unit (38) for applying labels to the containers transported by the container conveyor; and
a laser-marking module which is couplable to the coupling unit for laser-marking the containers transported by the container conveyor,
wherein the labeling module and the laser-marking module are interchangeably couplable to the coupling unit.

2. The device according to claim 1, further comprising:
a further coupling unit, which is arranged in front of or behind the coupling unit with respect to a container transport direction of the container conveyor; and
a further laser-marking module which is couplable to the further coupling unit for laser-marking the containers transported by the container conveyor.

3. The device according to claim 2, wherein at least one of:
the coupling unit and the further coupling unit (38) are of identical construction; and
the laser-marking module and the further laser-marking module are of identical construction.

4. The device according to claim 1, wherein at least one of:
the labeling module and the laser-marking module have rollers for moving over a substrate; and
the coupling unit is configured such that the labeling module is lifted when coupled to the coupling unit and that the laser-marking module is lifted when coupled to the coupling unit.

5. The device according to claim 1, wherein:
the laser-marking module has a movable module carriage and a laser-marking system for laser-marking, which is arranged as an exchangeable submodule on the module carriage.

6. The device according to claim 1, wherein:
the laser-marking module has at least one marking head for laser-marking the containers, and a position of the at least one marking head is at least one of height-adjustable, transversely adjustable to a transport direction of the container conveyor, longitudinally adjustable to a transport direction of the container conveyor, and radially adjustable to the container conveyor.

7. The device according to claim 1, wherein:
the laser-marking module comprises a plurality of marking heads for laser-marking different areas of the containers.

8. The device according to claim 7, wherein at least one of:
the multiple marking heads are arranged one above the other or laterally next to one another; and
the multiple marking heads share a laser source.

9. The device according to claim 1, wherein:
the laser-marking module has a suction device for suctioning out vapors generated during the laser-marking.

10. The device according to claim 1, wherein:
the laser-marking module has a cooling device which, for cooling a laser source of the laser-marking module, is connected to the laser source in a heat-transferring manner.

11. The device according to claim 1, wherein at least one of:
the laser-marking module comprises a cleaning device for automatically cleaning a focusing device of the laser-marking module; and
the laser-marking module has a detection device for at least one of a container-individual detection of a position and orientation of a marking region of the containers for adapting the laser-marking to the at least one of the detected position and the orientation.

12. The device according to claim 1, wherein:
the laser-marking module has a laser-protection housing for shielding the laser-marking of the containers.

13. The device according to claim 12, wherein:
at least a part of the laser-protection housing is movable between an operating position and a maintenance position.

14. The device according to claim 13, wherein:
the laser-marking module has a locking device for locking the at least a part of the laser-protection housing in the operating position, wherein the locking device is configured at least one of:
to lock the at least a part of the laser-protection housing in the operating position when the laser-marking module is coupled to the coupling unit; and
to release the at least a part of the laser-protection housing for movement into the maintenance position when the laser-marking module is uncoupled from the coupling unit.

15. The device according to claim 1, further comprising:
a control device that is configured:
to operate the device in a first operating mode with at least one first operating parameter when the labeling module is coupled to the coupling unit, and
to operate the device in a second operating mode with at least one second operating parameter, which is different from the at least one first operating parameter, when the laser-marking module is coupled to the coupling unit.

16. The device according to claim 15, wherein the at least one first operating parameter has a first conveying speed, and the at least one second operating parameter has a second conveying speed.

17. The device according to claim 16, wherein:
the container conveyor is configured to rotate the containers about a vertical axis of the respective container;
the at least one first operating parameter comprises at least one of a first container rotation speed and a first container rotation profile for rotating the containers about the vertical axis of the respective container; and
the at least one second operating parameter has at least one of a second container rotation speed, which differs from the first container rotation speed, and a second container rotation profile, which differs from the first container rotation profile, for rotating the containers about the vertical axis of the respective container.

18. The device according to claim 1, further comprising:
an inspection device which is configured to detect the laser markings applied to the containers by the laser-marking module and to adapt the operation of the device depending upon the detected laser markings.

19. A method for operating a device for marking containers according to claim 1, wherein the method comprises:
operating the device in a first operating mode, in which the labeling module is coupled to the coupling unit, with at least one first operating parameter; and
operating the device in a second operating mode, in which the laser-marking module is coupled to the coupling unit, with at least one second operating parameter, which is different from the at least one first operating parameter.

20. The method according to claim 19, wherein:
the at least one first operating parameter includes at least one of a first conveying speed, a first container rotation speed, and a first container rotation profile; and
the at least one second operating parameter includes at least one of a second conveying speed, a second container rotation speed, and a second container rotation profile.
